(19) United States
(12) Patent Application Publication
(10) Pub. No.: US 2003/0046259 A1
(43) Pub. Date: Mar. 6, 2003

(54) Method and system for performing in-line text expansion

(75) Inventors: Walter A. Manrique, Poughkeepsie, NY (US); Douglas J. Katt, Poughkeepsie, NY (US)

Correspondence Address: Philmore H. Colburn II, Cantor Colburn LLP, 55 Griffin Road South, Bloomfield, CT, 06002, US

(73) Assignee: International Business Machines Corporation, Armonk, NY

(21) Appl. No.: 09/942,351

(22) Filed: Aug. 29, 2001

(51) Int. Cl. G06F 7/00

(52) U.S. Cl. 707/1

(57) ABSTRACT

An exemplary embodiment of the present invention is a method for performing in-line text expansion. A program on a user system requests a data file from a server system. The data file is received and stored by the user system and then displayed. Displaying the data file includes reading a record from the data file and then displaying the header data on the user system screen. Additionally, if the display body flag for the record is set to “ON”, the body data contained in the record is also displayed on the user system screen. Each record in the data file is displayed in this manner. The user screen can also be updated in response to the user selecting particular fields on the screen. The first case is when the user selects header data for a particular record and the body display flag is set to “ON.” In response to the user selection the method will remove the associated body data from the screen and set the body display flag to “OFF.” The second case is when the user selects header data for a particular record and the body display flag is set to “OFF.” In this case, the method will add the associated body data to the screen and set the body display flag to “ON.” In this manner, based on user selection, portions of text can be expanded or contracted on the user screen. Additional embodiments include a system and storage medium for performing in-line text expansion.

### FIELD OF THE INVENTION

The present invention relates generally to displaying text using a browser. More particularly, the present invention relates to an improved browser method and system that reduces the number of times that the source of a document that is being displayed must be accessed by a browser.

### BACKGROUND OF THE INVENTION

The World Wide Web (WWW), or “web”, has become a well-known and versatile feature of the Internet. The web comprises many files or pages of information, distributed across many different servers. Each page is identified by an individual address or “Uniform Resource Locator (URL)” which, in turn, denotes both a server machine and a particular file or page on that machine. There may be many pages or URLs resident on a single server.

Typically, to utilize the web, a user runs a computer program called a web browser on a client computer system such as a personal computer. Examples of browser programs on the market include Microsoft Internet Explorer (™) and Netscape Navigator (™). The user interacts with the web browser to select a particular URL. The interaction causes the browser to send a request for the URL-identified page or file to the URL-identified server. Typically, the server responds to the request by retrieving the requested page and transmitting the data back to the requesting client utilizing hypertext transfer protocol (HTTP), a well known protocol in the art. The page received by the client is displayed to the user on the client machine.

Web pages can be formatted in accordance with computer programming languages such as hypertext markup language (HTML), Java, and extensible markup language (XML). A typical web page includes text together with embedded formatting commands, referred to as tags, that can be employed to control formatting features including font style, font size and layout. Using HTML as an example, the browser would parse the HTML script in order to display the text in accordance with the specified format.

Many web pages also contain one or more references to other web pages, which may or may not reside on the same server as the original page. Such references may be activated by the user selecting particular locations on the screen, typically by clicking a mouse control button. These references or locations are known as hyperlinks, and can be flagged by the web browser in a particular manner such as through the use of color coding the text link. If a user selects the hyperlinked text, then the referenced page is retrieved and replaces the currently displayed page. In this manner a user navigates through a single document or multiple related documents.

The use of hyperlinked text requires additional access to a server each time a hyperlink is selected in order to retrieve the URL page or file that is identified by the hyperlinked text. In addition, hyper linked text can require additional access to a server when it directs a user to another area of the same page of text. When navigating through a single document this additional access to a server can add an additional layer of delay in moving through the document and it requires that the user remain connected to the internet while viewing the document.

### SUMMARY OF THE INVENTION

An exemplary embodiment of the present invention is a method for performing in-line text expansion. A program on a user system requests a data file from a server system. The data file is received and stored by the user system and then displayed. Displaying the data file includes reading a record from the data file and then displaying the header data on the user system screen. Additionally, if the display body flag for the record is set to “ON”, the body data contained in the record is also displayed on the user system screen. Each record in the data file is displayed in this manner. The user screen can also be updated in response to the user selecting particular fields on the screen. The first case is when the user selects header data for a particular record and the body display flag is set to “ON.” In response to the user selection, the method will remove the associated body data from the screen and set the body display flag to “OFF.” The second case is when the user selects header data for a particular record and the body display flag is set to “OFF.” In this case, the method will add the associated body data to the screen and set the body display flag to “ON.” In this manner, based on user selection, or redirection to another location of the page, portions of text can be expanded or contracted on the user screen without requiring additional access to a server system. Additional embodiments include a system and storage medium for performing in-line text expansion.

### BRIEF DESCRIPTION OF THE DRAWINGS

FIG. 1 is a block diagram of an exemplary embodiment of a system for performing in-line text expansion.

FIG. 2 is an exemplary data file layout.

FIG. 3 is a flowchart of an exemplary process for displaying a data file on a user screen.

FIG. 4 is a flowchart of an exemplary process for updating the display of portions of the expandable text in response to user input.

FIG. 5 depicts an exemplary embodiment of an application for performing in-line text expansion using HTML tags.

### DETAILED DESCRIPTION OF THE INVENTION

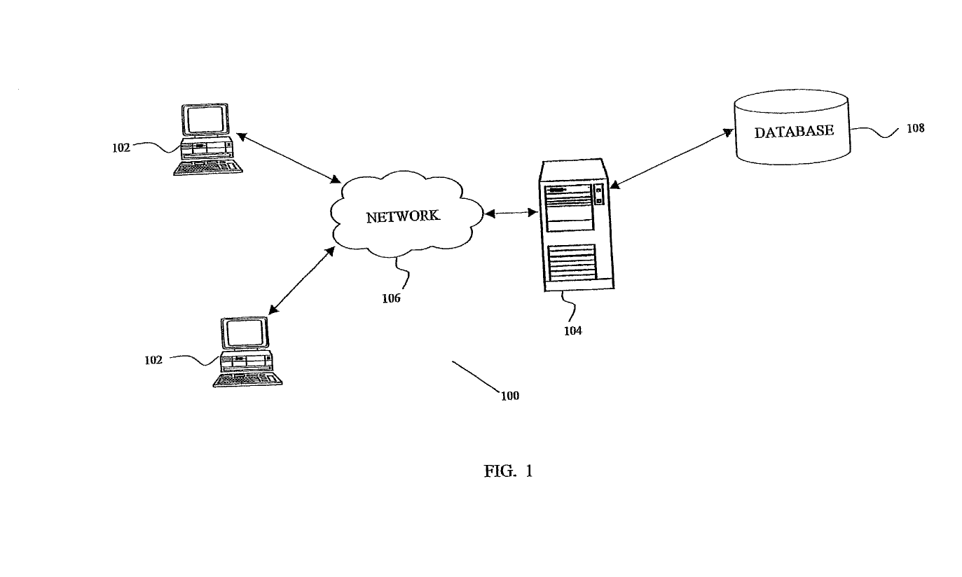

FIG. 1 is a block diagram of an exemplary system for performing in-line text expansion. The system of FIG. 1 includes user systems 102 through which a browser application will request a data file from the server system 104. The browser may be a web browser. In a preferred embodiment, the server system 104 executes a program that sends an entire data file to a requesting user system 102. The user systems 102 are coupled to a server system 104 via a network 106. Each user system 102 may be implemented using a general-purpose computer executing a browser that includes additional computer programs for carrying out the processes described herein. The user systems 102 store the data files and may be personal computers or server attached terminals. If the user systems 102 are personal computers, the processing described herein may be shared by user system 102 and server system 104 by providing an applet to the user system 102.

The network 106 may be any type of known network including a wide area network (WAN), a global network (e.g., Internet), or a local area network (LAN). The user system 102 may be coupled to the server system 104 through multiple networks (e.g., intranet and Internet) so that not all user systems 102 are coupled to the server system 104 through the same network. One or more of the user systems 102 and the server system 104 may be connected to network 106 in a wireless fashion and network 106 may be a wireless network. In a preferred embodiment, network 106 is the Internet and each user system 102 executes a web browser to contact the server system 104 through the network 106. Alternatively, a user system 102 may be implemented using a device programmed primarily for accessing network 106 such as WebTV.

The server system 104 maybe implemented using a server operating in response to a computer program stored in a storage medium accessible by the server. The server system 104 may operate as a network server (often referred to as a web server) to communicate with the user systems 102. The server system 104 handles sending and receiving information to and from user systems 102 and can perform associated tasks. The server system 104 may also include a firewall to prevent unauthorized access to the server system 104 and enforce any limitations on authorized access. For instance, an administrator may have access to the entire system and have authority to modify portions of the system. The firewall may be implemented using conventional hardware and/or software as is known in the art.

The server system 104 also operates as an applications server. The server system 104 executes one or more computer programs to retrieve requested data files. Processing may be shared by the user system 102 and the server system 104 by providing an application (e.g., java applet) to the user system 102. Alternatively, the user system can include a stand-alone software application for performing a portion of the processing described herein. It is understood that separate servers may be used to implement the network server functions and the applications server functions. Alternatively, the network server, firewall and the applications server can be implemented by a single server executing computer programs to perform the requisite functions.

Storage device 108 may be implemented using a variety of devices for storing electronic information. It is understood that storage device 108 may be implemented using memory contained in server system 104 or may be a separate physical device. Storage device 108 is logically addressable as a consolidated data source across a distributed environment such as network system 100. The implementation of local and wide-area database management systems to achieve the functionality of storage device 108 will be readily understood by those skilled in the art. Information stored in storage device 108 is retrieved and manipulated via server system 104. The storage device 108 may be accessed using any protocol known in the art including file transfer protocol (FTP). Storage device 108 contains the data files which will be retrieved and sent to a user system 102. The server system 104 may also operate as a database server and coordinate access to application data including data stored on storage device 108.

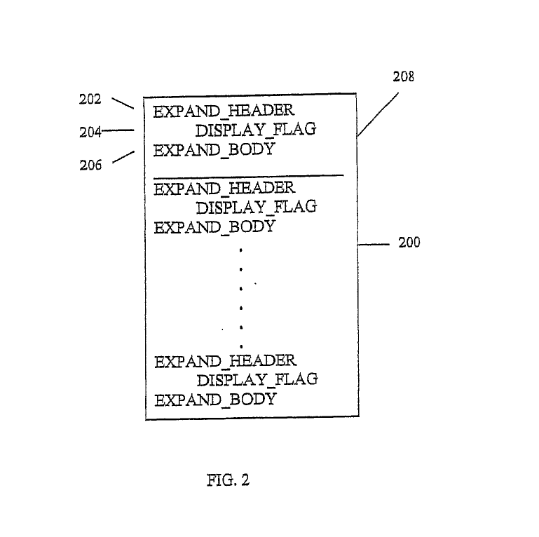

FIG. 2 is an embodiment of an exemplary data file layout for practicing the present invention. The data file contains multiple records 208 and each record comprises three data fields. The expand_header field 202 contains instructions to the user that additional text can be displayed on the screen. In addition, the expand_header field 202 may also describe the contents of the text that can be expanded. The display_flag field 206 can be set to “ON” or “OFF” and is used by an embodiment of the present invention to determine whether to display the expand_body field 204 on the screen. The expand_body field 204 contains the additional text which can be displayed or suppressed depending on the value of the display_flag field 206. This data file 200 is stored on storage device 108 and access is controlled by server system 104.

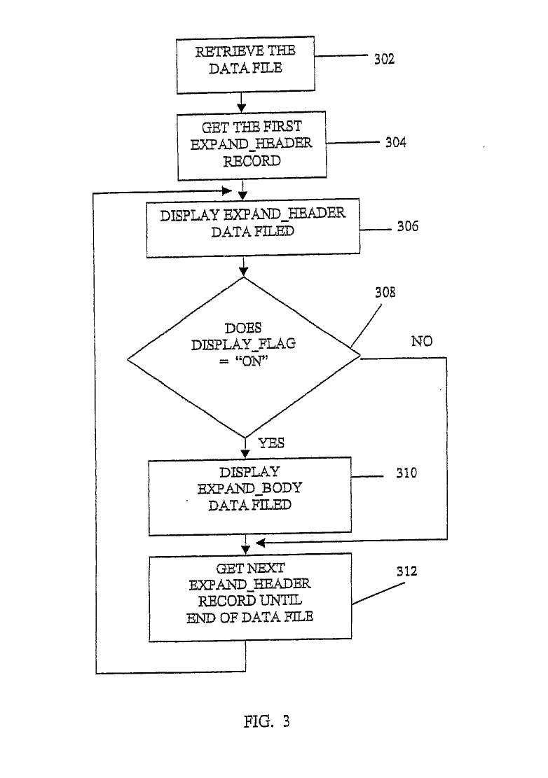

FIG. 3 is a flowchart of an exemplary process for displaying a data file on a user screen. In an exemplary embodiment, the program code to perform the steps shown in FIG. 3 is stored on user system 102 as part of the browser application that is also stored on user system 102. The first step 302 is to retrieve the data file 200 from the storage device 108 by making a request over the network 106 to the server system 104. The next step 304 is to access the first record from the data file 200. Next, at step 306, the data in the expand_header field 202 is displayed on the screen of the user system 102. At step 308 the value of the display_flag field 206 is checked. If the display_flag field 206 is equal to “ON” then the expand_body field 204 is displayed at step 310. If the display_flag field 206 is equal to “OFF” then step 310 is skipped. Step 312 gets the next record in the data file 200 and then steps 306, 308, and optionally 310 are performed. This continues until there are no more records 208 in the data file 200.

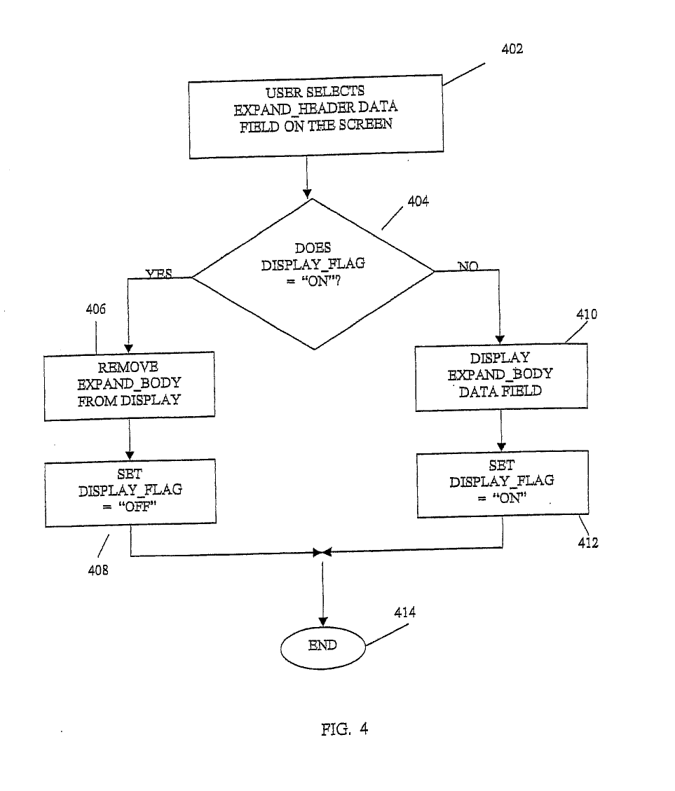

FIG. 4 is a flowchart of an exemplary embodiment of the present invention for updating the display portions of the expandable text in response to user input. Step 402 is performed when a user at user system 102 selects (e.g. clicks a mouse) the expand_header field 202 of a data record 208. When this occurs, step 404 checks to see if the display_flag is equal to “ON.” Step 404 is checking to see if the text is already being displayed to the user and therefore that the user is requesting that the text be removed from the screen. If the display_flag field 206 is equal to “ON” the expand_body 204 text is currently being displayed and steps 406 and 408 are performed to remove it from the display. In step 406 the expand_body field 204 is removed from the user system 102 display screen and at step 408 the display_flag field 206 is set to “OFF.” Otherwise, at step 404, if the display_flag field 206 was not equal to “ON”, the expand-body field 204 text is currently not being displayed and steps 410 and 412 are performed to add it to the display. In step 410 the expand_body field 204 is added to the user system 102 display screen and at step 412 the display_flag field 206 is set to “ON.” The processing ends at step 414 and restarts at step 402 the next time a user at user system 102 selects an expand_header field 202.

In an exemplary embodiment of the present invention the entire data file 200 is retrieved from the storage device 108 and stored on the user system 102 in step 302 of FIG. 3. Therefore, only one access to the network 106, the server system 104, and the storage device 108 is required by the user system 102. The remaining steps in FIG. 3 and the steps in FIG. 4 are performed by accessing records 208 stored locally to the user system 102. This allows a user system 102 to disconnect from the network 106, the server system 104, and the storage device 108 once the data file 200 has been retrieved.

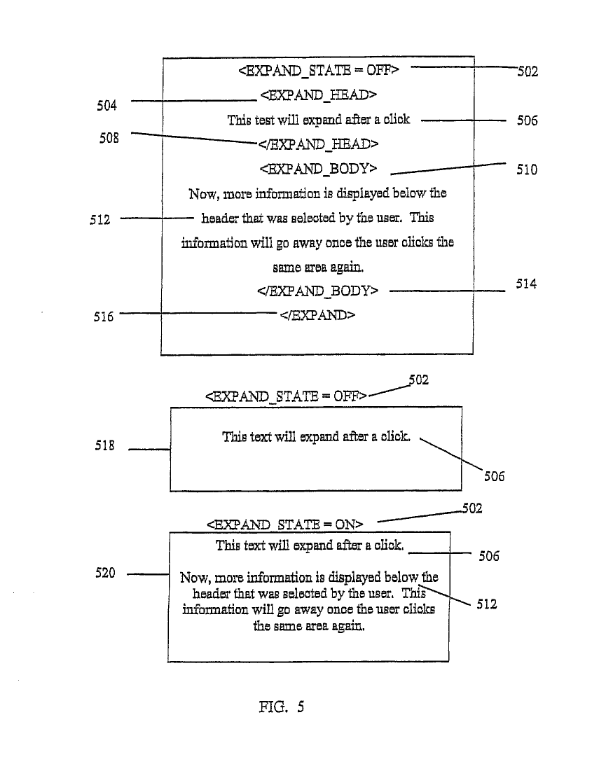

FIG. 5 depicts an exemplary embodiment of performing in-line text expansion using HTML tags. In an exemplary embodiment the HTML tags are appended to the user system 102 browser in order to carry out the following functions. The “<EXPAND>” tag 502 can have a STATE of either “ON” or “OFF”, the STATE corresponds to the display_flag 206 in FIG. 2. The “<EXPAND>” tag 502 is used to mark the beginning of an area of text that will be controlled by the user for expansion and contraction. The “</EXPAND>” tag 516 corresponds to the “<EXPAND>” tag 502 and marks the end of an area of text that is controlled by the user for expansion and contraction. The “<EXPANDHEAD>” tag 504 and the “</EXPANDHEAD>” tag 508 mark the beginning and end, respectively, of the area of text that controls the expansion and contraction of the text. The data 506 within these tags corresponds to the expand_header field 202 depicted in FIG. 2. The “<EXPANDBODY>” tag 510 is used to mark the beginning of an area of text that can be contracted and expanded based upon a user selecting text within the “<EXPANDHEAD>” 504 and “</EXPANDHEAD>” 508 tags. The text 512 following the “<EXPANDBODY>” tag 510 corresponds to the expand_body field 204 in FIG. 2. The “</EXPANDBODY>” tag 514 is used to mark the end of an area of text that can be expanded or contracted. FIG. 5 shows the resulting user screen 518 when “<EXPAND STATE=OFF>” and the resulting user screen 520 when “<EXPAND STATE=ON>.” Other implementations of the present invention are possible using other software tools including XML and Java.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiments for carrying out this invention, but that the invention will include all embodiments falling within the scope of the appended claims.

What is claimed is:

1. A method for performing in-line text expansion, said method comprising:
requesting a data file from a server;
receiving said data file from said server onto a user system;
displaying said data file on a user screen attached to said user system, said displaying including:
reading a record from said data file, said record including record header data, record body data, and a record body display flag;
adding said record header data to said user screen; and
adding said record body data to said user screen if said record body display flag is set to on; and
updating said user screen in response to selection of said record header data, said updating including:
removing said record body data from said user screen and setting said record body display flag to off if said record body display flag is set to on; and
adding said record body data to said user screen and setting said record body display flag to on if said record body display flag is set to off.

2. The method of claim 1 wherein said requesting a data file is performed using browser software.

3. The method of claim 1 wherein said receiving said data file is performed using browser software.

4. The method of claim 1 wherein said record includes HTML tags.

5. The method of claim 1 wherein said record includes XML tags.

6. The method of claim 1 wherein said displaying is performed using Java software.

7. The method of claim 1 wherein said updating is performed using Java software.

8. A system for performing in-line text expansion, said system comprising:
a user system in communication with a server over a network, said user system implementing a process comprising:
requesting a data file from said server;
receiving said data file from said server onto a user system;
displaying said data file on a user screen attached to said user system, said displaying including:
reading a record from said data file, said record including record header data, record body data, and a record body display flag;
adding said record header data to said user screen; and
adding said record body data to said user screen if said record body display flag is set to on; and
updating said user screen in response to selection of said record header data, said updating including:
removing said record body data from said user screen and setting said record body display flag to off if said record body display flag is set to on; and
adding said record body data to said user screen and setting said record body display flag to on if said record body display flag is set to off.

9. The system of claim 8 wherein said requesting a data file is performed using browser software.

10. The system of claim 8 wherein said receiving said data file is performed using browser software.

11. The system of claim 8 wherein said record includes HTML tags.

12. The system of claim 8 wherein said record includes XML tags.

13. The system of claim 8 wherein said displaying is performed using Java software.

14. The system of claim 8 wherein said updating is performed using Java software.

15. The system of claim 8 wherein said network is the internet.

16. The system of claim 8 wherein said network is an intranet.

17. A storage medium encoded with machine-readable computer program code for performing in-line text expansion, the storage medium storing instructions for causing a user system to implement a method comprising:
requesting a data file from a server;
receiving said data file from said server onto said user system;
displaying said data file on a user screen attached to said user system, said displaying including:
reading a record from said data file, said record including record header data, record body data, and a record body display flag;
adding said record header data to said user screen; and
adding said record body data to said user screen if said record body display flag is set to on; and
updating said user screen in response to selection of said record header data, said updating including:
removing said record body data from said user screen and setting said record body display flag to off if said record body display flag is set to on; and
adding said record body data to said user screen and setting said record body display flag to on if said record body display flag is set to off.

18. The storage medium of claim 17 wherein said requesting a data file is performed using browser software.

19. The storage medium of claim 17 wherein said receiving said data file is performed using browser software.

20. The storage medium of claim 17 wherein said record includes HTML tags.

21. The storage medium of claim 17 wherein said record includes XML tags.

22. The storage medium of claim 17 wherein said displaying is performed using Java software.

23. The storage medium of claim 17 wherein said updating is performed using Java software.

24. A data record comprising:
record header data;
record body data; and
a record body display flag, wherein status of said record body display flag controls display of said record body data, said status of said record body display flag being responsive to selection of said record header data.
